(19) United States
(12) Patent Application Publication
(10) Pub. No.: US 2012/0106214 A1
(43) Pub. Date: May 3, 2012

(54) CIRCUIT FOR CONVERTING DC INTO AC PULSED VOLTAGE

(75) Inventors: Chenyang Liu, Shanghai (CN); Ang Ding, Shanghai (CN); Bin Wu, Shanghai (CN)

(73) Assignee: KONINKLIJKE PHILIPS ELECTRONICS N.V., EINDHOVEN (NL)

(21) Appl. No.: 13/381,211

(22) PCT Filed: Jun. 24, 2010
(86) PCT No.: PCT/IB2010/052883

§ 371 Date: Dec. 28, 2011

(30) Foreign Application Priority Data
Jun. 30, 2009 (CN) 200910139595.8

(51) Int. Cl. H02M 7/537

(52) U.S. Cl. 363/97

(57) ABSTRACT

The present invention proposes a circuit for converting DC into AC pulsed voltage. The circuit comprises two controllable semiconductor switches. By controlling the opening and closing of the semiconductor switches, the circuit can operate in different modes, i.e. high input voltage mode and low input voltage mode. The circuit for converting DC into AC pulsed voltage, proposed in the present invention, is suitable for a wide input voltage range. When the circuit is used as the driver circuit of a DBD lamp, the DBD lamp can still operate normally by switching to low-voltage DC supply in case of an AC supply failure, and the DBD lamp has a higher luminous efficiency.

### TECHNICAL FIELD

The present invention relates to a circuit for converting DC into AC pulsed voltage, particularly to a driver circuit for driving dielectric barrier discharge lamps.

### BACKGROUND OF THE INVENTION

Dielectric barrier discharge (also referred to as “DBD”) is also known as “silent discharge”. Dielectric barrier discharge lamps with xenon filling attract wide interest for the advantages of stable operation independent of ambient temperature, immediate light production, long lifetime, high-energy UV radiation, absence of mercury, and so on.

DBD lamps can be operated with continuous excitation or with pulsed excitation. It has been shown that pulsed operation in conjunction with a modified gas pressure leads to a significantly higher luminous efficiency of the lamp. For high-efficiency DBD lamps, pulsed operation is preferred, while continuous excitation is commonly used in applications where efficiency requirements are not high.

Before ignition, DBD lamps are near-to-perfect capacitive loads. This is due to the fact that the two electrodes are encapsulated with dielectric materials while being geometrically close to each other. After ignition there is an additional capacitance and a dissipative component, both induced by the gas discharge. Thus the standard electrical model for any DBD lamp can be deemed as consisting of two capacitances and a resistance. Usually, ignition of a DBD lamp may require voltages of approximately 5 kVpp and in the normal operating mode the driving voltage may be approximately 3 kVpp, while the lamp power factor is lower than 0.3. Furthermore, the operating frequency and the dv/dt of the driving voltage have an impact on the lamp efficiency and the discharge stability.

By virtue of high-energy UV radiation produced after gas discharging, water disinfection is one main application of DBD lamps. Usually, DBD lamps for disinfection applications work under a power supply voltage of 220 V or 100 V. In case of power failure, the DBD lamp needs to automatically switch to a backup battery to keep working. Usually, the voltage of the backup battery is quite low, 12 V for example. Therefore, how to make the driver circuit of DBD lamps operate under both high input voltage and low input voltage and acquire high luminous efficiency is a problem that needs to be solved.

### SUMMARY OF THE INVENTION

The present invention proposes a circuit for converting DC into AC pulsed voltage in an embodiment. The circuit comprises two controllable semiconductor switches. By controlling the opening and closing of the controllable semiconductor switches, the circuit can operate in different modes, i.e. high input voltage mode and low input voltage mode.

According to an embodiment of the present invention, there is proposed a circuit for converting DC into AC pulsed voltage, the circuit comprising a converter circuit, a detector unit and a controller unit. Said converter circuit is configured to drive a load and comprises a first controllable semiconductor switch, a second controllable semiconductor switch, a capacitor and a transformer, wherein said first controllable semiconductor switch is connected in series with the primary side of said transformer and the series circuit of said second controllable semiconductor switch and said capacitor is connected in parallel with the primary side of said transformer or said first controllable semiconductor switch. Said detector unit is configured to detect the input voltage of said converter circuit Said controller unit is configured to control the operating mode of said converter circuit using a first preset control mode or a second preset control mode, according to the magnitude of the input voltage detected by said detector unit.

According to another embodiment of the present invention, there is proposed an electronic driving circuit for driving DBD lamps, comprising above-described circuit for converting DC into AC pulsed voltage.

According to another embodiment of the present invention, there is proposed a method configured to control a circuit for converting DC into AC pulsed voltage, wherein said converter circuit is configured to drive a load and comprises a first controllable semiconductor switch, a second controllable semiconductor switch, a capacitor and a transformer, said first controllable semiconductor switch being connected in series with the primary side of said transformer, the series circuit of said second controllable semiconductor switch and said capacitor being connected in parallel with the primary side of said transformer or said first controllable semiconductor switch, the method comprising the following steps: detecting the input voltage of said converter circuit and controlling the operation of said converter circuit using a first preset control mode or a second preset control mode according to the magnitude of the input voltage detected by said detector unit.

The circuit for converting DC into AC pulsed voltage, proposed in the present invention, is suitable for a wide input voltage range. When the circuit is used as the driver circuit of DBD lamps, the DBD lamp can still operate normally by switching to low-voltage DC supply in case of an AC supply failure, and the DBD lamp has higher luminous efficiency.

### BRIEF DESCRIPTION OF THE DRAWINGS

The above and other objects, characteristics and merits of the present invention will become more apparent from the following detailed description considered in connection with the accompanying drawings, in which:

FIG. 1 is a schematic diagram of a circuit for converting DC into AC pulsed voltage according to an embodiment of the present invention;

FIG. 2 is a flow chart of an operating process of the circuit in FIG. 1;

FIG. 3(a) is a schematic diagram showing a first preset control mode of the first and second controllable semiconductor switches in FIG. 1;

FIGS. 3(b) and 3(c) are schematic diagrams corresponding to the DBD lamp operating in the ignition mode and in the normal operating mode, respectively, representing waveforms of voltage and current of the lamp when the first and second controllable semiconductor switches are controlled by the first preset control mode shown in FIG. 3(a);

FIG. 4(a) is a schematic diagram showing another first preset control mode of the first and second controllable semiconductor switches shown in FIG. 1;

FIGS. 4(b) and 4(c) are schematic diagrams corresponding to the DBD lamp operating in the ignition mode and the normal operating mode, respectively, representing waveforms of voltage and current of the DBD lamp when the first and second controllable semiconductor switches are controlled by the first preset control mode shown in FIG. 4(a);

FIG. 5 is another schematic diagram showing another first preset control mode of the first and second controllable semiconductor switches in FIG. 1 and the corresponding voltage waveform and current waveform when the DBD lamp operates in the ignition mode;

FIG. 6 is another flow chart of an operating process of the circuit in FIG. 1 according to another embodiment of the present invention;

FIG. 7 is a schematic diagram showing a second preset control mode of the first and second controllable semiconductor switches in FIG. 1 and the corresponding voltage waveform and current waveform of the DBD lamp, as well as the corresponding current waveform of the first controllable semiconductor switch when the DBD lamp operates in the second preset control mode;

FIG. 8 is a schematic diagram of an equivalent circuit of the circuit in FIG. 1 when the input voltage of the converter circuit in FIG. 1 is lower than a second preset threshold value, i.e. the second controllable semiconductor switch is opened;

FIG. 9 is a schematic diagram of an equivalent circuit of the resonant circuit composed of the load and the transformer when the load in FIG. 1 is a DBD lamp;

FIG. 10 is a schematic diagram of a circuit for converting DC into AC pulsed voltage according to another embodiment of the present invention;

FIG. 11 is a flow chart of a method of controlling a circuit for converting DC into AC pulsed voltage according to an embodiment of the present invention, wherein the similar reference numerals are used to denote similar steps, characteristics, means, or modules throughout the figures.

### DETAILED DESCRIPTION OF THE EMBODIMENTS

Hereinafter, embodiments of the present invention are described in detail with reference to the accompanying drawings.

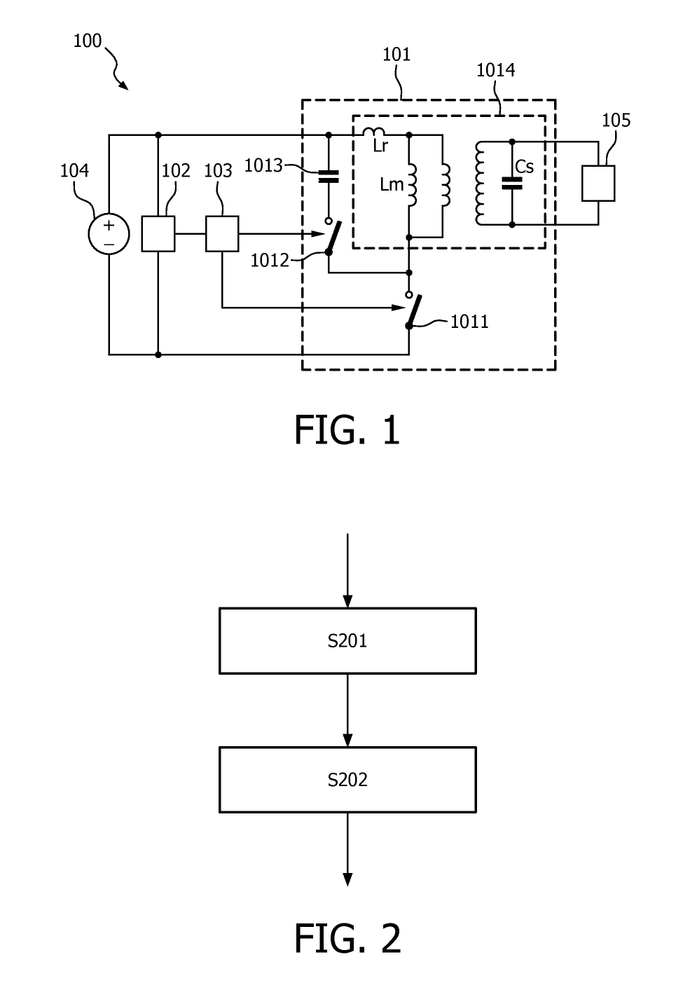

FIG. 1 is a schematic diagram of a circuit 100 for converting DC into AC pulsed voltage according to an embodiment of the present invention. In FIG. 1, the circuit 100 comprises a converter circuit 101, a detector unit 102, a controller unit 103, a power supply 104 and a load 105, wherein the converter circuit 101 comprises a first controllable semiconductor switch 1011, a second controllable semiconductor switch 1012, a capacitor 1013 and a transformer 1014, the first controllable semiconductor switch 1011 being connected in series with the primary side of the transformer 1014 and the series circuit of the second controllable semiconductor switch 1012 and the capacitor 1013 being connected in parallel with the primary side of the transformer 1014. FIG. 1 illustrates an equivalent circuit of the transformer 1014, comprising a leakage inductance Lr, a magnetizing inductance Lm, a parasitic capacitance Cs and a primary-to-secondary turns ratio of 1:n, wherein the value of n can be modified according to the requirements of a practical circuit. The first and second controllable semiconductor switches 1011 and 1012 can be composed of semiconductor devices such as bi-polar transistors, field effect transistors, and so on.

FIG. 2 illustrates a flow chart of an operating process of the circuit in FIG. 1 according to an embodiment of the present invention. Hereinafter, the operation process of the circuit in FIG. 1 is described in detail with reference to FIG. 2, taking it for example that the load 105 is a DBD lamp.

First, in step S201, the detector unit 102 detects the magnitude of the input voltage of the converter circuit, i.e. the magnitude of the output voltage of the power supply 104. Those skilled in the art should understand that the power supply 104 can be a DC power supply or composed of an AC power supply and rectifying circuits.

Next, in step S202, the controller unit 103 controls the operation of the converter circuit using a first preset control mode or a second preset control mode according to the detection results of the detector unit 102, i.e. the magnitude of the input voltage of the circuit.

Specifically, if the detector unit 102 detects that the input voltage of the converter circuit is higher than a first preset threshold value, then the controller unit 103 controls the opening and closing of the first controllable semiconductor switch 1011 and the second controllable semiconductor switch 1012 using the first preset control mode. If the detector unit 102 detects that the input voltage is lower than a second preset threshold value, then the controller unit 103 controls the opening and closing of the first controllable semiconductor switch 1011 and the second controllable semiconductor switch 1012 using the second preset control mode.

If the input voltage is higher than the first preset threshold value, for example 110 V, 220 V, and so on, the circuit in FIG. 1 operates in a forward mode. The first preset control mode is a mode adopted for the forward mode, controlling the opening and closing of the first controllable semiconductor switch 1011 and the second controllable semiconductor switch 1012. If the input voltage is lower than the second preset threshold value, for example 5V, 12 V, and so on, the circuit in FIG. 1 operates in a flyback mode. The second preset control mode is a mode adopted for the flyback mode, controlling the opening and closing of the first controllable semiconductor switch 1011 and the second controllable semiconductor switch 1012.

Hereinafter, the first preset control mode and the second preset control mode are illustrated respectively.

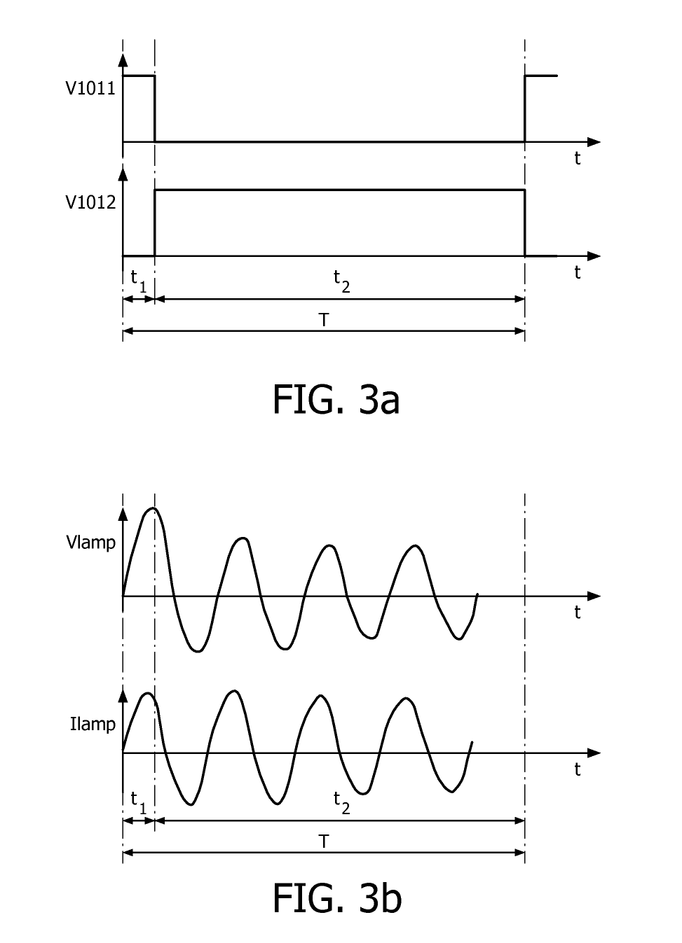

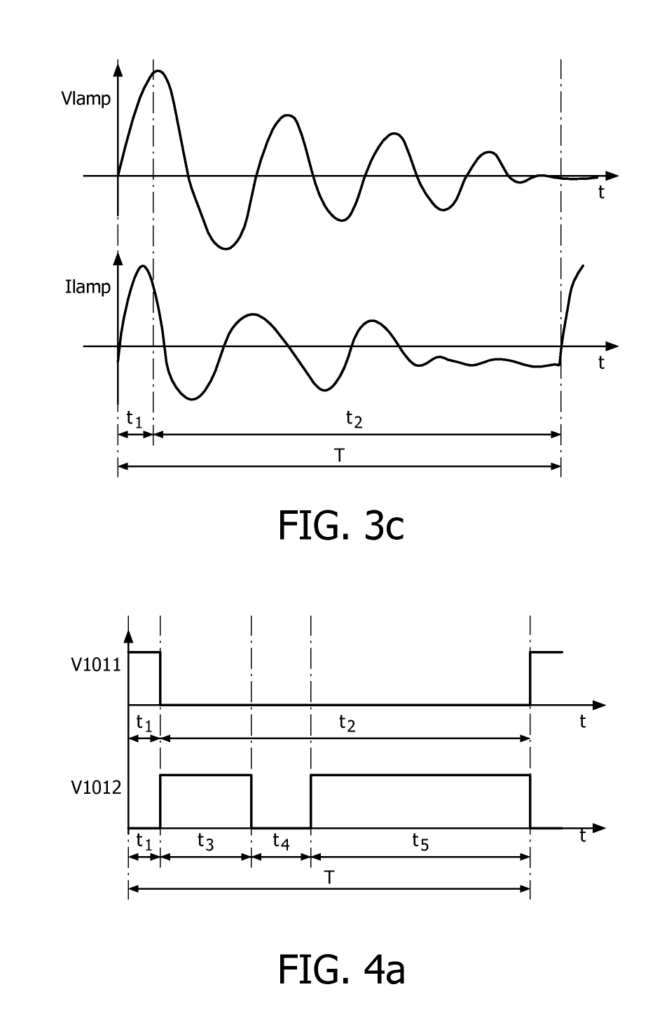

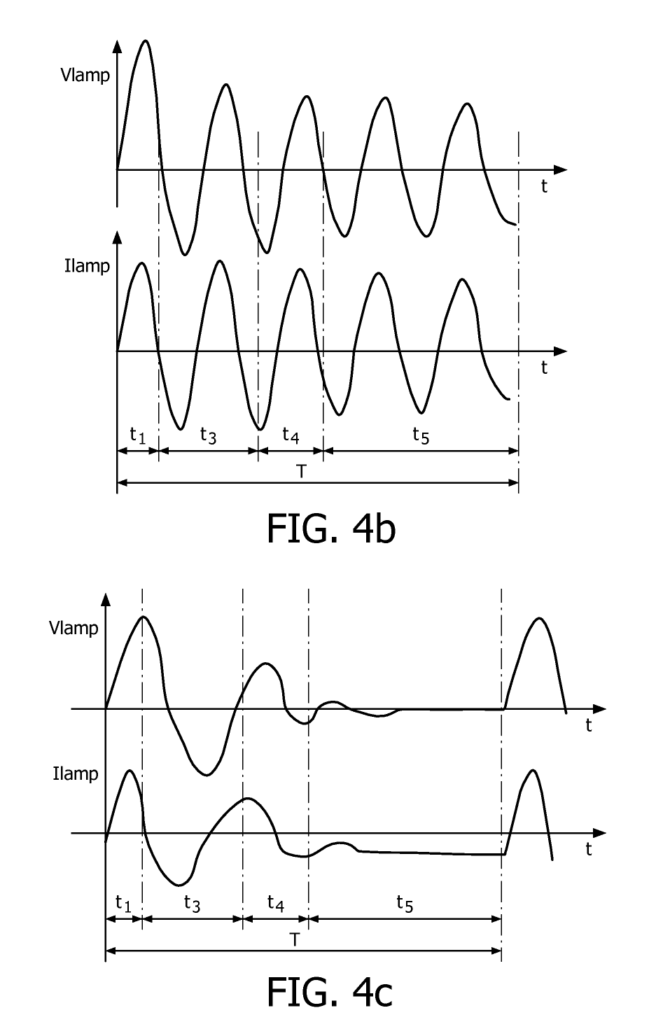

If the detector unit 102 detects that the input voltage of the converter circuit is higher than the first preset threshold value, then the controller unit 103 controls the first controllable semiconductor switch 1011 and the second controllable semiconductor switch 1012 so that the switches are closed and opened periodically in the mode shown in FIG. 3(a). As shown in FIG. 3(a), during a time period T, the first controllable semiconductor switch 1011 is closed for a period of time t1 and then opened for a period of time t2, and the second controllable semiconductor switch 1012 is opened for a period of time t1 and then closed for a period of time t2, wherein t1+t2=T. In an embodiment, t1 is much shorter than t2. In other words, the controller unit 103 generates driving signals V₁₀₁₁ and V₁₀₁₂ for driving the first and second controllable semiconductor switches 1011 and 1012 and applies these signals to the first and second controllable semiconductor switches 1011 and 1012, respectively. In FIG. 3(a) and the following FIGS. 4(a), 5, and 7, the high-level voltage denotes a voltage enabling the closing of the first or second controllable semiconductor switches 1011 or 1012, respectively, and the low-level voltage denotes a voltage enabling the opening of the first or second controllable semiconductor switches 1011 or 1012, respectively.

It should be noted that the value of t1 determines the input energy during the time period T. The value of T can be modified according to the power requirements of the DBD lamp and the electrical parameters of the converter circuit. In an embodiment, the value of T can be from 5 μs to 50 μs and the value of t1 can be from 100 μs to 1 μs. The values of T and t1 can be constant or change over time.

Usually, the operating modes of DBD lamps can be classified into two kinds: the ignition mode and the normal operating mode. According to the characteristics of a DBD lamp, before ignition, i.e. in the ignition mode, the DBD lamp is a near-to-perfect capacitive load. This is due to the fact that the electrodes are encapsulated with dielectric materials while being geometrically close to each other. After ignition there is an additional capacitance and a dissipative component, both induced by the gas discharge. Thus the standard electrical model for the DBD lamp comprises two capacitances and a resistance. Usually, the ignition of a DBD lamp may require voltages of approximately 5 kVpp and in normal operating mode the driving voltage may be approximately 3 kVpp.

FIGS. 3(b) and 3(c) are schematic diagrams corresponding to a DBD lamp operating in the ignition mode and in the normal operating mode, respectively, representing waveforms of voltage and current of the DBD lamp when the first preset control mode in FIG. 3(a) is adopted. As shown in FIGS. 3(b) and 3(c), during a time period T, there is still much electric energy lost due to the slow voltage and current damping. In order to decrease unnecessary energy loss, an opening period can be inserted in the period during which the second controllable semiconductor switch is supposed to be closed.

As shown in FIG. 4(a), the controller unit 103 controls the first controllable semiconductor switch 1011 and the second controllable semiconductor switch 1012 so that the switches are opened and closed periodically in the mode shown in FIG. 4(a). As shown in FIG. 4(a), during a time period T, the controller unit 103 controls the first controllable semiconductor switch so that the switch is closed for a period of time t1 and then opened for a period of time t2, and the controller unit 103 controls the second controllable semiconductor switch 1012 so that the switch is opened for a period of time t1, then closed for a period of time t3, then opened for a period of time t4, and then closed for a period of time t5, wherein t1+t2=T and t1+t3+t4+t5=T.

FIGS. 4(b) and 4(c) are schematic diagrams corresponding to the DBD lamp operating in the ignition mode and the normal operating mode, respectively, representing the waveforms of voltage and current of the DBD lamp when the first preset control mode in FIG. 4(a) is adopted. As shown in FIG. 4(c), when the DBD lamp operates in the normal operating mode the amplitudes of the voltage and the current are well suppressed and the electric energy is saved effectively. In FIG. 4(b), however, there is still much electric energy lost due to the slow voltage and current damping.

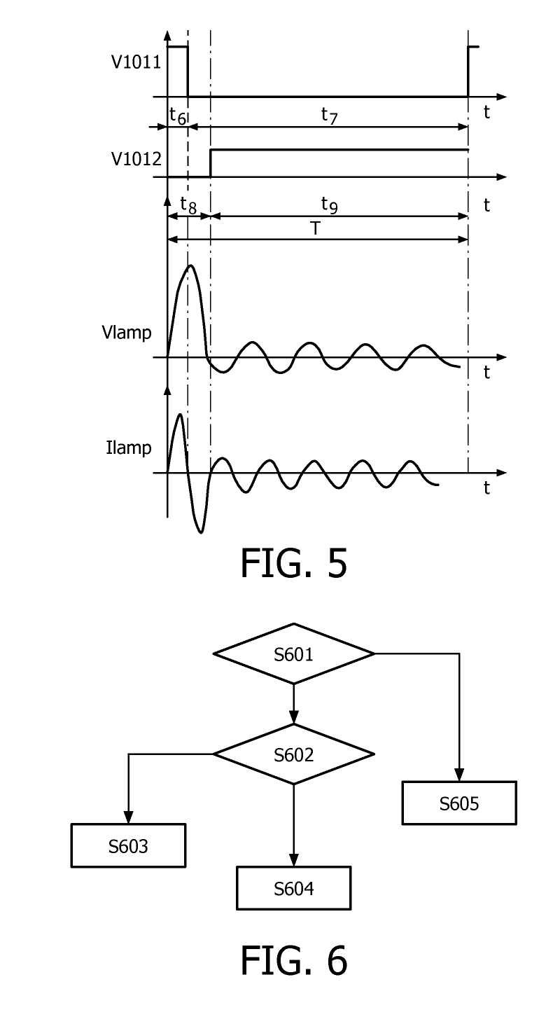

Optionally, for DBD lamps operating in the ignition mode, the first preset control mode shown in FIG. 5 can be adopted.

First, the controller unit 103 detects whether the DBD lamp operates in the ignition mode or in the normal operating mode. Alternatively, the controller unit 103 can also indicate the detector unit 102 to detect whether the DBD lamp operates in the ignition mode or in the normal operating mode and then forward the detection results to the controller unit 103. If the DBD lamp operates in the ignition mode, then the controller unit 103 controls the first controllable semiconductor switch 1011 and the second controllable semiconductor switch 1012 so that the switches are closed and opened periodically in the mode shown in FIG. 5. As shown in FIG. 5, during a time period T, the controller unit 103 controls the first controllable semiconductor switch 1011 so that the switch is closed for a period of time t6 and then opened for a period of time t7, and the controller unit 103 controls the second controllable semiconductor switch 1012 so that the switch is opened for a period of time t8 and then closed for a period of time t9, wherein t6+t7=T, t8+t9=T, and t6<t8.

The lower half part of FIG. 5 illustrates the schematic diagrams of waveforms of voltage Vlamp and current Ilamp respectively. As shown in FIG. 5, when the first preset control mode in FIG. 5 is adopted and the DBD lamp operates in the ignition mode, the amplitudes of both the voltage at the lamp's terminals and the current through the lamp are well suppressed and the electric energy is effectively saved.

FIG. 6 illustrates a flow chart of the operation of the circuit 100 in FIG. 1 when differentiating the magnitude of the input voltage and the operation mode of the DBD lamp, which is described in detail hereinafter.

Specifically, in step S601, the detector unit 102 detects the input voltage of the converter circuit. If the input voltage is higher than the first preset threshold value, then, in step S602, the controller 103 detects the operation mode of the DBD lamp. Specifically, the controller unit 103 can detect the voltage at the terminals of the DBD lamp or the current through the lamp. As described above, the voltage at the terminals of the DBD lamp in the ignition mode is much higher than in the normal operating mode. In the ignition mode, the average current through the DBD lamp is zero while in the normal operating mode, the average current through the DBD lamp is much higher than zero.

If the DBD lamp operates in the normal operating mode, then in step S603, the controller unit 103 controls the first controllable semiconductor switch 1011 and the second controllable semiconductor switch 1012 so that the switches are opened and closed periodically in the mode shown in FIG. 4(a). As shown in FIG. 4(a), during a time period T, the controller unit 103 controls the first controllable semiconductor switch 1011 so that the switch is closed for a period of time t1 and then opened for a period of time t2, and the controller unit 103 controls the second controllable semiconductor switch 1012 so that the switch is opened for a period of time t1, then closed for a period of time t3, then opened for a period of time t4, and then closed for a period of time t5, wherein t1+t2=T and t1+t3+t4+t5=T. FIG. 4(c) illustrates a schematic diagram of the waveforms of both the voltage Vlamp at the terminals of the DBD lamp and the current Ilamp through the DBD lamp in this case.

If in step S601 the detector unit 102 detects that the input voltage of the converter circuit is higher than the first preset threshold value, and if in step S602 the controller unit 103 detects that the DBD lamp operates in the ignition mode, then in step S604 the controller unit 103 controls the first controllable semiconductor switch 1011 and the second controllable semiconductor switch 1012 so that the switches are opened and closed periodically in the mode shown in FIG. 5. As shown in FIG. 5, during a time period T, the controller unit controls the first controllable semiconductor switch 1011 so that the switch is closed for a period of time t6 and then opened for a period of time t7, and the controller unit 103 controls the second controllable semiconductor switch 1012 so that the switch is opened for a period of time t8 and then closed for a period of time t9, wherein t6+t7=T, t8+t9=T, and t6<t8. The lower half part of FIG. 5 illustrates a schematic diagram of waveforms of both the voltage at the terminals of the DBD lamp and the current through the lamp in this case.

It can be seen from the schematic diagrams in FIG. 4(c) and FIG. 5, showing the waveforms of both the voltage Vlamp at the terminals of the DBD lamp and the current Ilamp through the lamp, that the amplitudes of the voltage and the current are well suppressed and the electric energy is effectively saved due to an opening period, as shown in FIG. 4(a), inserted in the period during which the second controllable semiconductor switch is supposed to be closed.

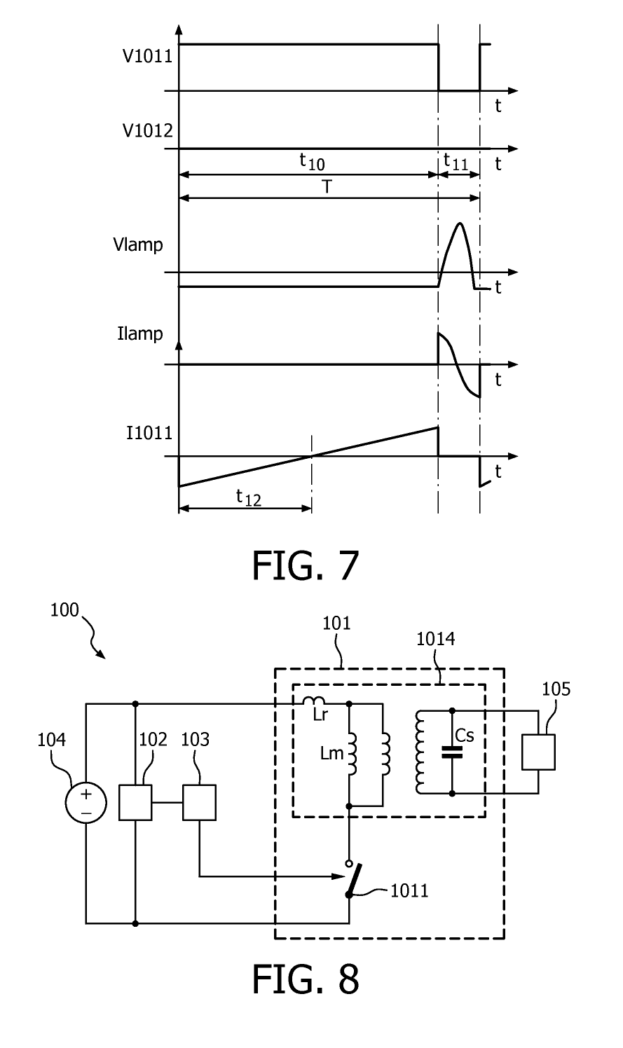

If in step S601 the detector unit 102 detects that the input voltage of the converter circuit is lower than the second preset threshold value, then in step S605 the controller unit 103 controls the opening and closing of the first controllable semiconductor switch 1011 and the second controllable semiconductor switch 1012 using the second preset control mode. FIG. 7 illustrates a schematic diagram of the second preset control mode according to an embodiment of the present invention. As shown in FIG. 7, the controller unit 103 opens the second controllable semiconductor switch 1012 and controls the closing and opening of the first controllable semiconductor switch 1011 using the control mode in FIG. 7. A schematic diagram of the equivalent circuit in this case is shown in FIG. 8.

As shown in FIG. 7, during a time period T, the controller unit 103 controls the first controllable semiconductor switch 1011 so that the switch is closed for a period of time t10 and then opened for a period of time t11, wherein t10+t11=T, t10>t11, and t11 is longer than half the resonant period of the circuit composed of the transformer 1014 and the load 105 and shorter than the sum of half the resonant period and the freewheeling time of the first controllable semiconductor switch 1011.

The freewheeling time of the first controllable semiconductor switch means the time of the current transiting from the secondary side to the primary side of the transformer, flowing reversely through the first controllable semiconductor switch 1011 and feeding the electric energy back to the source of the circuit. FIG. 7 schematically illustrates the waveform of the current through the first controllable semiconductor switch 1011, wherein t12 denotes the freewheeling time of the first controllable semiconductor switch 1011.

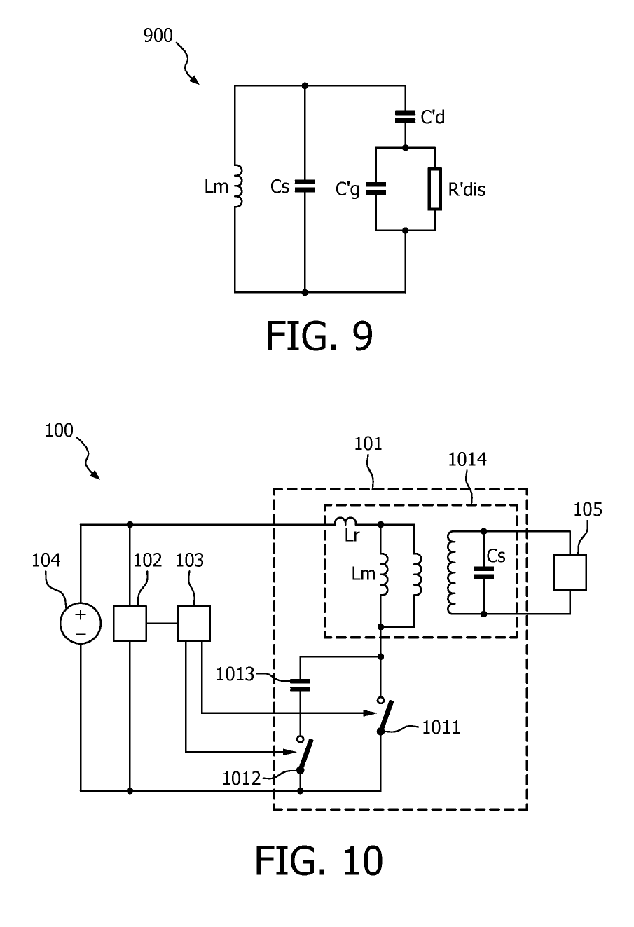

Taking it for example that the load 105 is a DBD lamp, as described above, in the normal operating mode the DBD lamp and the transformer 1014 compose the resonant circuit 900 shown in FIG. 9. The resonant circuit 900 comprises the magnetizing inductance Lm and the parasitic capacitance Cs of the transformer 1014 and the DBD lamp's equivalent, being a series-parallel circuit composed of a capacitance C′d, a capacitance C′g, and a resistance R′dis, wherein the capacitance C′d is connected in series with the parallel circuit of the capacitance C′g and the resistance R′dis. The resonant period Tr of the resonant circuit shown in FIG. 9 can be expressed by the following formula:

$${T}_{r} = 2 π \sqrt{Lm ( Cs + \frac{{C}^{′} d \cdot {C}^{′} g}{{C}^{′} d + {C}^{′} g} )}$$

Specifically, after the transformer is wound, its parameters, such as the magnetizing inductance Lm and the parasitic capacitance Cs, can be measured. Likewise, after the DBD lamp is made, its parameters, such as the capacitances C′d and C′g, can be measured. The capacitances C′d and C′g of the DBD lamp when operating in the ignition mode, are different from those corresponding to the DBD lamp's normal operating mode, resulting in a lower resonant frequency of the circuit corresponding to the normal operating mode in comparison with that corresponding to the ignition mode. Optionally, determination of the value of t11 is based on the lower resonant frequency corresponding to the normal operating mode.

When the circuit in FIG. 8 operates in the flyback mode, the input voltage of the converter circuit is relatively low. Thus, during a time period T, the closing period t10 is longer than the opening period t11 for the first controllable semiconductor switch 1011. During the closing period of the first controllable semiconductor switch 1011, the transformer 1014 stores energy. During the closing period of the first controllable semiconductor switch 1011, the transformer 1014 feeds energy to the DBD lamp.

FIG. 7 also illustrates a schematic diagram of the waveforms of both the voltage Vlamp at the terminals of the DBD lamp and the current Ilamp through the lamp.

It should be noted that in FIG. 7 the value of t11 determines the input energy during a time period T and the value of T can be modified according to the power requirements of the DBD lamp and the electrical parameters of the converter circuit. The value of T and t11 can be constant or change over time.

As a variation of the circuit in FIG. 1, FIG. 10 illustrates a schematic diagram of a circuit converting DC into AC pulsed voltage according to another embodiment of the present invention. Different from the topology in FIG. 1, the series circuit of the second controllable semiconductor switch 1012 and the capacitor 1013 is connected in parallel with the first controllable semiconductor switch 1011, instead of with the primary side of the transformer 1014. The operation process of the circuit in FIG. 10 is the same as that of the circuit in FIG. 1 and is not repeated herein.

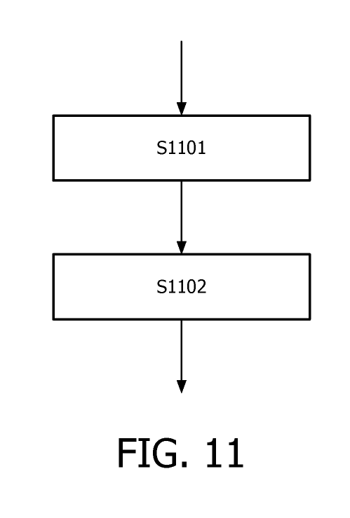

FIG. 11 illustrates a flow chart of a method of controlling a circuit for converting DC into AC pulsed voltage according to an embodiment of the present invention. The converter circuit is configured to drive a load, the circuit comprising a first controllable semiconductor switch, a second controllable semiconductor switch, a capacitor and a transformer, wherein the first controllable semiconductor switch is connected in series with the primary side of the transformer and the series circuit of the second controllable semiconductor switch and the capacitor is connected in parallel with the primary side of the transformer or the first controllable semiconductor switch. A schematic diagram of such a circuit is shown in FIG. 1 or FIG. 10.

First, step S1101 detects the input voltage of the converter circuit. In an embodiment, step S1101 can be performed by the detector unit 102 in FIG. 1 or FIG. 10.

Next, in step S1102 controlling the operation of the converter circuit using the first preset control mode or the second preset control mode according to the voltage magnitude detected in step S1101. In an embodiment, step S1102 can be performed by the controller unit 103 in FIG. 1 or FIG. 10.

Specifically, in step S1102, if the input voltage of the converter circuit is higher than a first preset threshold value, then the opening and closing of the first controllable semiconductor switch and the second controllable semiconductor switch are controlled using a first preset control mode. The first preset control mode can be the mode shown in FIG. 3(a) or FIG. 4(a).

Optionally, when the input voltage of the converter circuit is higher than the first preset threshold value, the first controllable semiconductor switch and the second controllable semiconductor switch can be controlled using different control modes according to the operation modes of the load. Taking it for example that the load is a DBD lamp operating in an ignition mode or in a normal operating mode, for the ignition mode, the first preset control mode is the mode shown in FIG. 5 while for the normal operating mode, the first preset control mode is the mode shown in FIG. 4(a).

If the input voltage of the converter circuit is lower than a second preset threshold value, then controlling the opening and closing of the first controllable semiconductor switch and the second controllable semiconductor switch uses a second preset control mode. The second preset control mode can be the mode shown in FIG. 7.

It should be noted that the above-described periodicity means that in FIGS. 3(a), 4(a), 5, and 7 the value of T is constant over time. Optionally, the value of T can also change over time. The first and second preset threshold values can be modified according to the practical input voltage of the converter circuit, and are not limited by the illustrative values recited above. The values of t1 to t11 can be modified according to the requirements of a practical circuit and the values of t1 and t2 can be the same or different for respective embodiments. The function of the detector unit 102 and the controller unit 103 can be implemented by mere hardware or by a combination of software and hardware. For example, the functions of detector unit 102 and controller unit 103 can be implemented by an MCU executing corresponding programs.

Above, embodiments of the present invention have been described. It should be noted that the present invention is not limited to the foregoing specific embodiments. Those skilled in the art can make various variations or modifications within the scope of the appended claims.

1. A circuit for converting DC into AC pulsed voltage, comprising:
a converter circuit, configured to drive a load, said converter circuit comprising a first controllable semiconductor switch, a second controllable semiconductor switch, a capacitor, and a transformer, wherein said first controllable semiconductor switch is connected in series with the primary side of said transformer and the series circuit of said second controllable semiconductor switch and said capacitor is connected in parallel with the primary side of said transformer or said first controllable semiconductor switch;
a detector unit, configured to detect the input voltage of said converter circuit; and
a controller unit, configured to control the operation of said converter circuit using a first preset control mode or a second preset control mode according to the magnitude of the input voltage detected by said detector unit.

2. A circuit according to claim 1, wherein said controller unit is configured to control the opening and closing of said first and second controllable semiconductor switches using the first preset control mode if said input voltage is higher than a first preset threshold value.

3. A circuit according to claim 2, wherein said first preset control mode is configured to control said first and second controllable semiconductor switches so that the switches are opened and closed periodically in the following mode:
during a time period T, said first controllable semiconductor switch being closed for a period of time t1 and then opened for a period of time t2, and said second controllable semiconductor switch being opened for a period of time t1 and then closed for a period of time t2, wherein t1+t2=T.

4. A circuit according to claim 2, wherein said first preset control mode is configured to control said first and second controllable semiconductor switches so that the switches are opened and closed periodically in the following mode:
during a time period T, said first controllable semiconductor switch being closed for a period of time t1 and then opened for a period of time t2, and said second controllable semiconductor switch being opened for a period of time t1, then closed for a period of time t3, then opened for a period of time t4, and then closed for a period of time t5, wherein t1+t2=T and t1+t3+t4+t5=T.

5. A circuit according to claim 3, wherein said load operates in an ignition mode or a normal operating mode and said first preset control mode further comprises detecting whether said load operates in the ignition mode or in the normal operating mode; and
if said load operates in the ignition mode, controlling said first and second controllable semiconductor switches so that the switches are opened and closed periodically in the following mode:
during a time period T, said first controllable semiconductor switch being closed for a period of time t6 and then opened for a period of time t7, and said second controllable semiconductor switch being opened for a period of time t8 and then closed for a period of time t9, wherein t6+t7=T, t8+t9=T, and t6<t8.

6. A circuit according to claim 1, wherein said controller unit is configured to control the opening and closing of said first and second controllable semiconductor switches using the second preset control mode if said input voltage is lower than a second preset threshold value.

7. A circuit according to claim 6, wherein said second preset control mode is configured to:
open said second controllable semiconductor switch; and
control said first controllable semiconductor switch so that the switch is closed and opened periodically in the following mode:
during a time period T, said first controllable semiconductor switch being closed for a period of time t10 and then opened for a period of time t11, wherein t10+t11=T and t10>t11, t11 being longer than half the resonant period of the circuit composed of said transformer and said load and shorter than the sum of said half resonant period and the freewheeling time of said first controllable semiconductor switch 1011.

8. An electronic driving circuit for driving a dielectric barrier discharge lamp, comprising the circuit according to claim 1.

9. A method configured to control a circuit for converting DC into AC pulsed voltage, wherein said converter circuit is configured to drive a load, said converter circuit comprising a first controllable semiconductor switch, a second controllable semiconductor switch, a capacitor, and a transformer, wherein said first controllable semiconductor switch is connected in series with the primary side of said transformer and the series circuit of said second controllable semiconductor switch and said capacitor is connected in parallel with the primary side of said transformer or said first controllable semiconductor switch, the method comprising the steps of:
a. detecting the input voltage of said converter circuit;
b. controlling the operation of said converter circuit using a first preset control mode or a second preset control mode according to the magnitude of the input voltage detected by said detector unit.

10. A method according to claim 9, wherein said step b comprises the following step:
controlling the opening and closing of said first and second controllable semiconductor switches using the first preset control mode if said input voltage is higher than a first preset threshold value.

11. A method according to claim 10, wherein said first preset control mode comprises the following step:
controlling said first and second controllable semiconductor switches so that the switches are opened and closed periodically in the following mode:
during a time period T, said first controllable semiconductor switch being closed for a period of time t1 and then opened for a period of time t2, and said second controllable semiconductor switch being opened for a period of time t1 and then closed for a period of time t2, wherein t1+t2=T.

12. A method according to claim 10, wherein said first preset control mode comprises the following step:
controlling said first and second controllable semiconductor switches so that the switches are opened and closed periodically in the following mode:
during a time period T, said first controllable semiconductor switch being closed for a period of time t1 and then opened for a period of time t2, and said second controllable semiconductor switch being opened for a period of time t1, then closed for a period of time t3, then opened for a period of time t4, and then closed for a period of time t5, wherein t1+t2=T and t1+t3+t4+t5=T.

13. A method according to claim 11, wherein said load operates in an ignition mode or in a normal operating mode and said first preset control mode further comprises the steps of:
detecting whether said load operates in the ignition mode or in the normal operating mode; and
if said load operates in the ignition mode, controlling said first and second controllable semiconductor switches so that the switches are opened and closed periodically in the following mode:
during a time period T, said first controllable semiconductor switch being closed for a period of time t6 and then opened for a period of time t7, and said second controllable semiconductor switch being opened for a period of time t8 and then closed for a period of time t9, wherein t6+t7=T, t8+t9=T, and t6<t8.

14. A method according to claim 9, wherein said step b comprises the following step:
controlling the opening and closing of said first and second controllable semiconductor switches using the second preset mode if said input voltage is lower than a second preset threshold value.

15. A method according to claim 14, wherein said second preset control mode comprises the steps of:
opening said second controllable semiconductor switch; and
controlling said first controllable semiconductor switch so that the switch is closed and opened periodically in the following mode:
during a time period T, said first controllable semiconductor switch being closed for a period of time t10 and then opened for a period of time t11, wherein t10+t11=T and t10>t11, t11 being longer than half the resonant period of the circuit composed of said transformer and said load and shorter than the sum of said half the resonant period and the freewheeling time of said first controllable switch 1011.
